(19) United States
(12) Patent Application Publication
(10) Pub. No.: US 2002/0095613 A1
(43) Pub. Date: Jul. 18, 2002

(54) Synchronizing motion and time-based data for transfer between a server and a client

(76) Inventors: Shinya Matsuoka, Mountain View, CA (US); John P. Hwa, Fremont, CA (US); Mark S. Callow, San Jose, CA (US)

Correspondence Address: LEE & HAYES PLLC, 421 W RIVERSIDE AVENUE SUITE 500, SPOKANE, WA, 99201

(21) Appl. No.: 10/068,829

(22) Filed: Feb. 6, 2002

Related U.S. Application Data
(63) Continuation of application No. 08/900,421, filed on Jul. 25, 1997, now abandoned.

(51) Int. Cl. G06F 1/12

(52) U.S. Cl. 713/400

(57) ABSTRACT

A method and apparatus for synchronizing asynchronous time-based and motion data in a system in which the time-based data and motion data are transmitted by a server over a network to a client including retrieving a time-based data stream and a motion data stream at the server. Each stream comprising frames of data. One of the time-based data stream and the motion stream is variably buffered to produce two streams having synchronized frames. The synchronized frames are used at the client for playback of synchronized motion and time-based data to a user.

### BACKGROUND

The invention relates generally to synchronizing motion data with time-based data for transfer between a server and a client.

As shown in FIG. 1 a server 100 may send data to clients 102 via a network 103, e.g., the Internet or an intranet. The transfer of data from a server to a client is limited by the bandwidth capabilities of the network connecting the two devices. In the case of the Internet, the available bandwidth is too small for certain types of data transfers.

The bandwidth of the Internet is adequate to transfer three dimensional (3D) motion capture data which may then be displayed on a monitor 106 attached to the client 102. Examples of 3D motion capture data include data provided by a body suit 116, a dataglove or another sensor system. The 3D motion capture data may be integrated with other information such as background data or other special effects (as provided by a keyboard 118, slider 120 or joy stick 122) to provide a scene for display on client 102.

In addition to motion data, server 100 and client 102 may use the Internet to transfer time-based data. Examples of time-based data include live or stored audio data such as voice data from a microphone 114 or prerecorded audio tracks stored in a data storage device 110. The audio data may be played back on a speaker 104 attached to client 102. Typically, transfers of time-based data do not consume much bandwidth and may be easily supported by the Internet.

### SUMMARY

In general, in one aspect, the invention features a method of synchronizing asynchronous time-based and motion data in a system in which the time-based data and motion data are transmitted by a server over a network to a client including retrieving a time-based data stream and a motion data stream at the server. Each stream comprising frames of data. One of the time-based data stream and the motion stream is variably buffered to produce two streams having synchronized frames. The synchronized frames are used at the client for playback of synchronized motion and time-based data to a user.

Aspects of the invention include numerous features. The variably buffering may occur at the server. A difference between delays for the motion stream and the time-based data stream through the server may be calculated to determine an amount of variable buffering for a faster of the two streams. Only those data values for a frame that have changed since a last frame was transmitted are in turn transmitted over the network. The network is the Internet. The motion data is mapped to control the movement of a virtual figure displayed in a scene at the client. The motion data is generated by a body suit. The motion data includes background data for use in producing a scene at the server.

Data transfer from the server to the client is concurrent with the receipt of the time-based data stream and motion data stream at the server. The time-based data is voice data. The synchronized data frames include one or more data channels. The server transmits on the network at a predetermined interval between synchronized data frames a descriptor packet which describes each channel contained in the synchronized data frames such that a client may join in progress a multicast of synchronized data frames.

The time-based data is a pre-recorded audio track and the method further includes synchronizing playback of the pre-recorded audio track at the server and buffering of the pre-recorded audio track to allow for coupling with motion data generated in time with the playback of the prerecorded audio track. Synchronized frames output from the server to the client are sequenced to provide for ordered playback of the synchronized frames to a user at the client.

In another aspect, the invention features a method of packaging synchronized frames of data where each frame includes one or more channels of data in a system in which synchronized frames are transmitted by a server over a network to a client including storing a last data value for each channel in each frame transmitted over the network. New synchronized frames are retrieved for transmission over the network. Only data for channels having changed data values are packaged and transmitted over the network.

Aspects of the invention includes numerous features A descriptor packet is transmitted at a predetermined interval over the network. The descriptor packet includes channel descriptors for each channel in the synchronized frames.

In another aspect the invention features an apparatus for synchronizing asynchronous time-based and motion data in a system in which the time-based data and motion data are transmitted by a server over a network to a client including a data retriever for retrieving a time-based data stream and a motion data stream at the server. Each of the streams includes frames of data. A data stream synchronizer is provided for buffering one of the time-based data stream and the motion stream to produce two streams having synchronized frames. A packetizer is provided for packaging synchronized frames of motion data and time-based data for use at the client for playback of synchronized motion and time-based data to a user.

Aspects of the invention include numerous features. A multicaster is included for multicasting the synchronized motion and time-based data to clients coupled to the network. The packetizer includes a storage device and a comparator. The storage device is for storing data values last transmitted over the network for each channel in each of the synchronized frames. The comparator is for comparing data values for new frames with the data values stored in the storage device. The packetizer only packages for transmission to the client channel data for channels having changed data values as determined by the comparator.

In another aspect the invention features a method for playing back time-based and motion based data that has been synchronized including mapping the motion based data to control the movement of a virtual figure in a scene displayed at a client and playing back in synchronization with movement of the virtual figure the time-based data.

In another aspect the invention features a method of synchronizing asynchronous motion and audio data in a system in which the motion and the audio data are transmitted by a server computer to one or more clients. The clients provide a real time output of synchronized motion and audio data. The method includes retrieving an audio stream including voice data and a motion data stream including one or more motion data channels at the server and calculating a delay through the server for a frame of data on each of the streams. A difference between the delay for the audio stream and the motion data stream is calculated to determine which of the two streams is faster. A faster of the streams is variably buffered to synchronize the audio stream and the motion data stream resulting in two output streams having synchronized data frames. The synchronized data frames are packaged and multicast to one or more clients over a network. At each client computer, he synchronized data frames are used for synchronous playback of the audio and motion data for display to a user.

Among the advantages of the invention are one or more of the following.

Motion data may be synchronized with other time-based data and transmitted over, multicast and viewed in a normal bandwidth wide area client server network.

Multiple motion data inputs may be synchronized with multiple time-based media data inputs and provided to a client to view in real time over a normal bandwidth wide area client server network.

Motion data may be combined along with stored or live audio data and then synchronized prior to transfer over a network to a client. Network clients can view the synchronized motion and time-based data for real time playback or may subscribe to a real time multicast already in progress.

Other features and advantages of the invention will become apparent from the following description and from the claims.

### DRAWINGS

FIG. 1 is a schematic block diagram of a client server computer network.

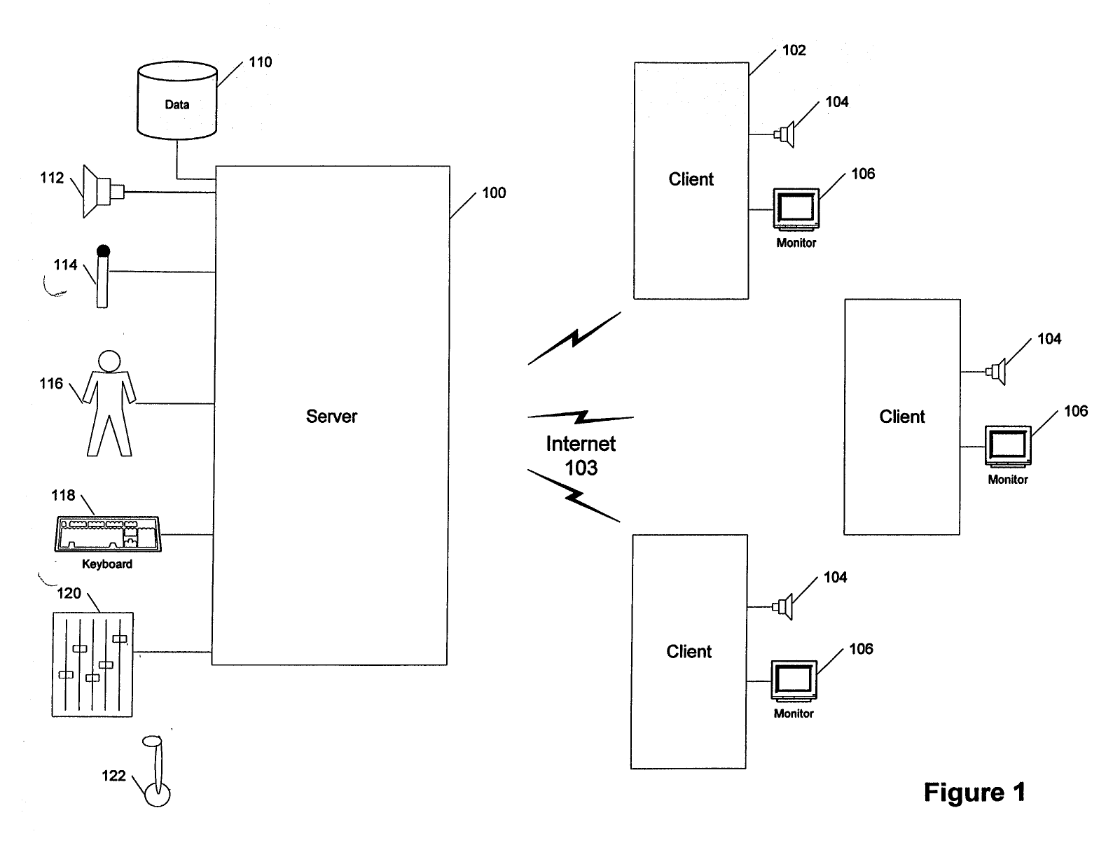

FIG. 2 is a schematic block diagram of a client server computing system for the transfer of synchronized motion capture and time-based data according to the present invention.

FIG. 3 is a detailed schematic block diagram a server of FIG. 2.

FIG. 4 is a more detailed schematic block diagram of the server of FIG. 3.

FIG. 4a is a state diagram for implementing data synchronization and transfer from a server to a client according to the present invention.

FIG. 4b is a flow diagram of the process steps executed in the maintenance state for calculating the delay in input streams received by the server of FIG. 4.

FIG. 4c is flow diagram for a process of transmitting data between a server and client over a low bandwidth network according to the present invention.

FIG. 5 is a more detailed schematic block diagram of a client of FIG. 2.

FIG. 6 is an alternative embodiment of a client including local data synchronization according to one embodiment of the present invention.

### DESCRIPTION

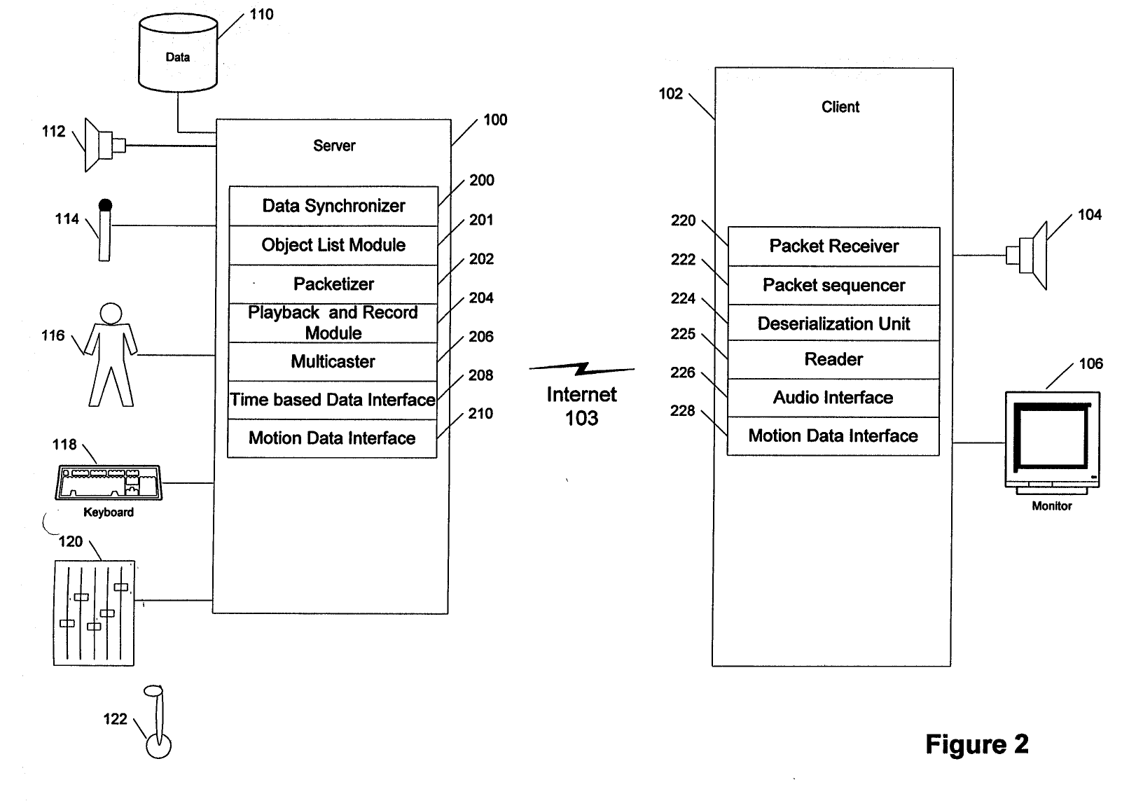

The computer network illustrated in FIG. 2 which is capable of transmitting synchronized motion and time-based data includes a server (server) 100 having a data synchronizer 200, object list module 201, packetizer 202, record and playback module 204, multicaster 206, time-based data interface 208 and motion data interface 210. Server 100 may multicast synchronized motion and time-based data to one or more clients 102. Client 102 includes a packet receiver 220, a packet sequencer 222, a deserialization unit 224, a reader 225, an audio interface 226 and a motion data interface 228. The motion data interface 228 may be a browser application capable of supporting the display of virtual reality modeling language (VRML) files provided over the network for display on a CRT (display 106) attached to client 102. Audio interface 226 is coupled to a speaker 104 for playing the audio data received from the server 100 in synchronization with the display of motion data on display 106.

Three dimensional (3D) motion data may be provided as an input to the server 100 from a body suit 116 attached by an Ethernet medium (not shown), a slider device 120 and a keyboard 118. Body suit 116 provides sensor data which may be mapped to control the movement of a virtual figure displayed in a 3D scene at the client. In one embodiment, the body suit is a “Motionstar” body suit produced by Ascension, Inc., of Vermont. Alternatively, a dataglove (“Fifthglove”) produced by 5DT, Inc., Pretoria, South Africa, may be used to provide 3D motion capture data.

The motion capture data received from an input device, such as a body suit, may be divided into a number of groups (channel groups), that include one or more channels. For the purposes of these discussions, a channel group is a group of related sensor inputs. In one embodiment, the data from a body suit is divided into seven distinct channel groups; left and right (L/R) hand, L/R arm, L/R leg, and head.

Slider device 120 may be used to control a feature in a 3D scene displayed at the client. In one embodiment, slider device 120 provides an output which is mapped to control the facial features of a virtual figure displayed in the 3D scene at the client.

Background information which is to be displayed on the 3D scene including background and foreground shading, scenery, environmental or other types of display data is specified by user input through keyboard 118. The 3D motion data is provided to the motion data interface 210, synchronized with voice data received from microphone 114 and background audio data from a file stored in data storage device 110 and multicast over network 103.

At the client, a browser application executing a viewer displays a three dimensional (3D) scene including the virtual figure. Movement of the figure (body and facial) is controlled by the motion data received from the server. The background of the scene may be modified based on the motion data received from keyboard 118. Audio interface 226 provides synchronized audio accompaniment for the 3D scene over speaker 104.

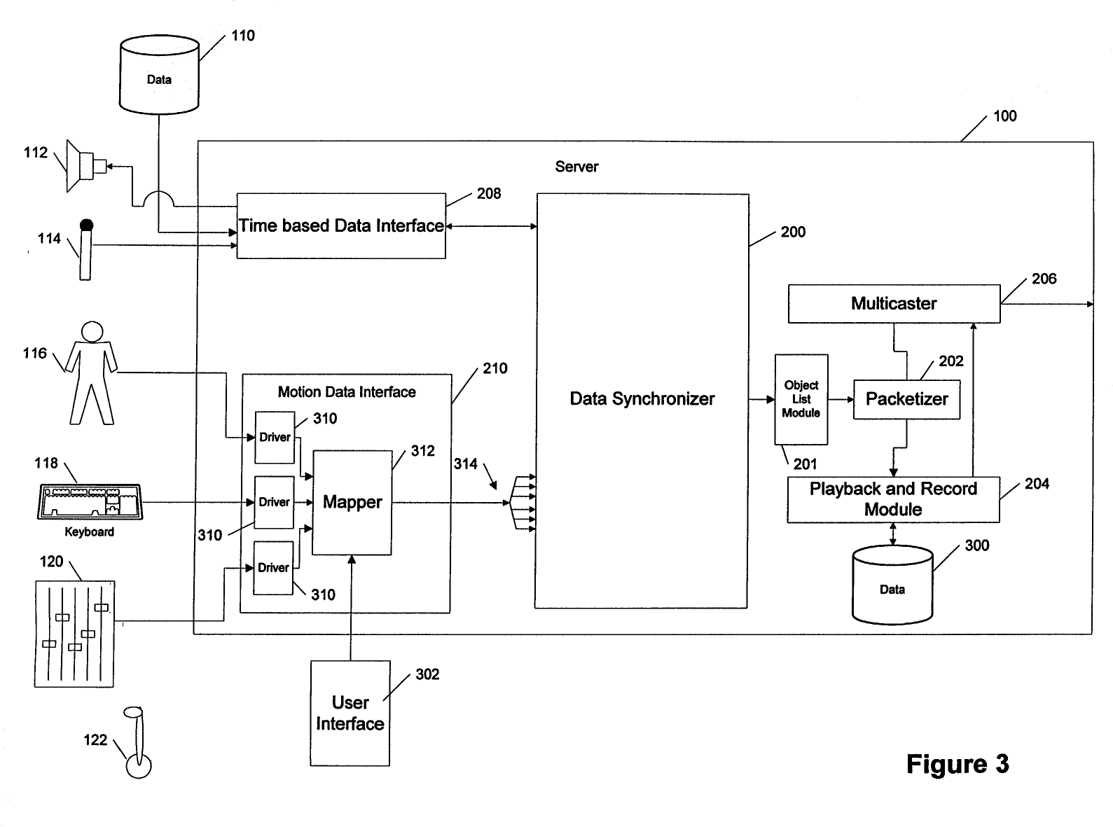

Having provided a simplified description of one use of the synchronized motion and time-based data network disclosed herein, other uses of the synchronized data may be contemplated. The use of the synchronized motion and time-based data is independent of the synchronization process disclosed herein. Referring now to FIG. 3, the motion data interface 210 includes user interface 302, drivers 310 and a mapper 312. In one embodiment, the motion data interface 210 is a software application executing on the server 100 which receives inputs from various data sources (input devices) coupled to drivers 310. In the 3D scene application described above, inputs for controlling the display of a virtual person in a 3D scene is provided through motion data interface 210.

Mapper 312 receives as an input user preferences through user interface 302 for mapping the various different input motion data streams to channels in an output motion data stream 314 which is provided as an input to data synchronizer 200. Motion data interface 210 may be a software application executing on the server named “ALIVE!” which is available through the Protozoa Corporation in San Francisco, Calif.

Data synchronizer 200 receives as an input both time-based data input streams and output motion data stream 314, and provides synchronized frames of motion and time-based data to object list module 201. One or more time-based data streams are provided as an input to data synchronizer 200 through the time-base data interface 208. Voice data accompanying the motion data may be provided by microphone 114 to time-based data interface 208. For example, it may be desirable to capture audio as well as motion data from a user operating a body suit. The accompanying audio data is sensed by microphone 114 and is synchronized with the motion data by data synchronizer 200 in order to assure that the resultant audio and display data displayed by a client appears synchronized.

Packetizer 202 reads channel data from object list module 201 and creates a data packet for the synchronized motion and time-based data. The packets may be transferred to multicaster 206 for multicast over network 103 (not shown) to one or more clients. Alternatively, the packets may be transferred to a playback and record module 204 where they are formatted into a file structure for storage in a storage element 300. Playback and record module 204 includes a file reader (not shown) for retrieving files stored in storage element 300 and for separating the packets for transfer to multicaster 206 for multicast off line.

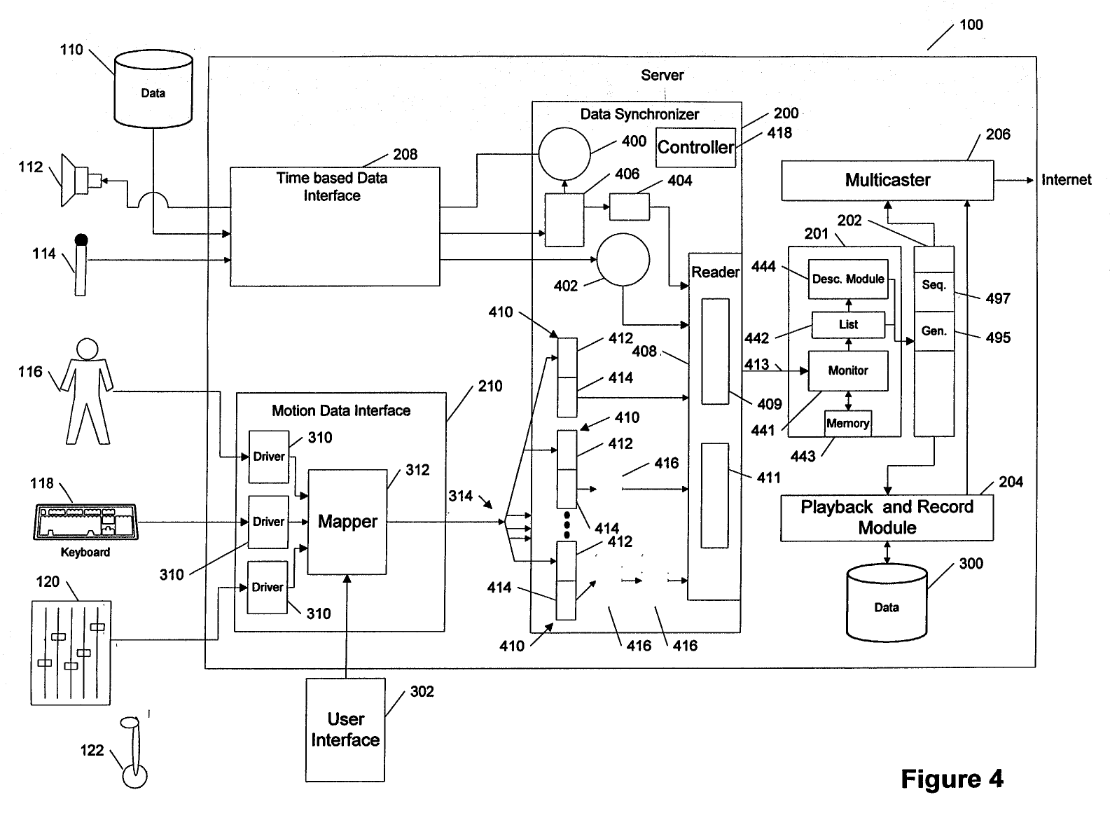

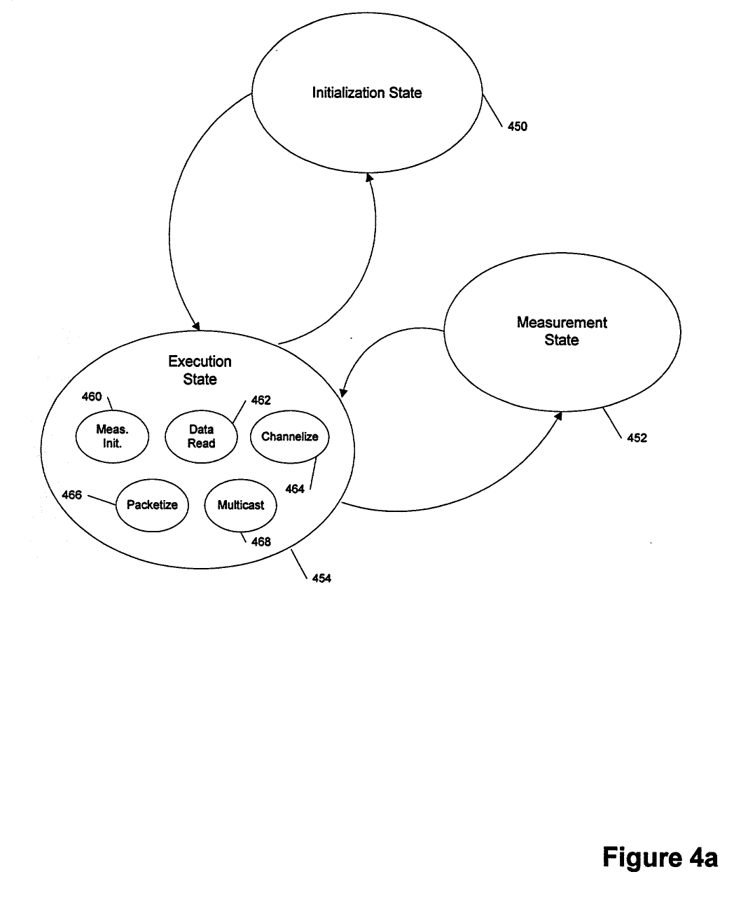

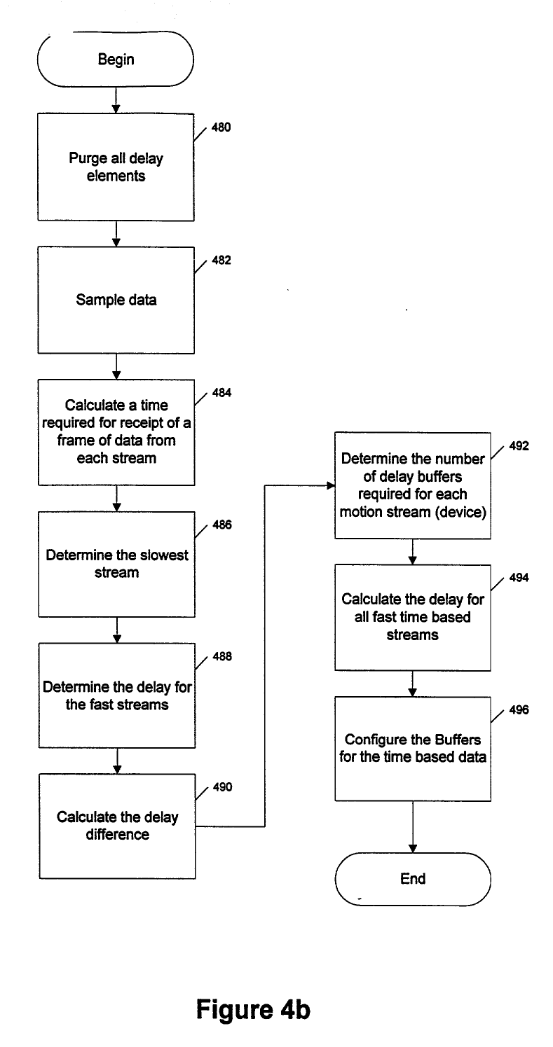

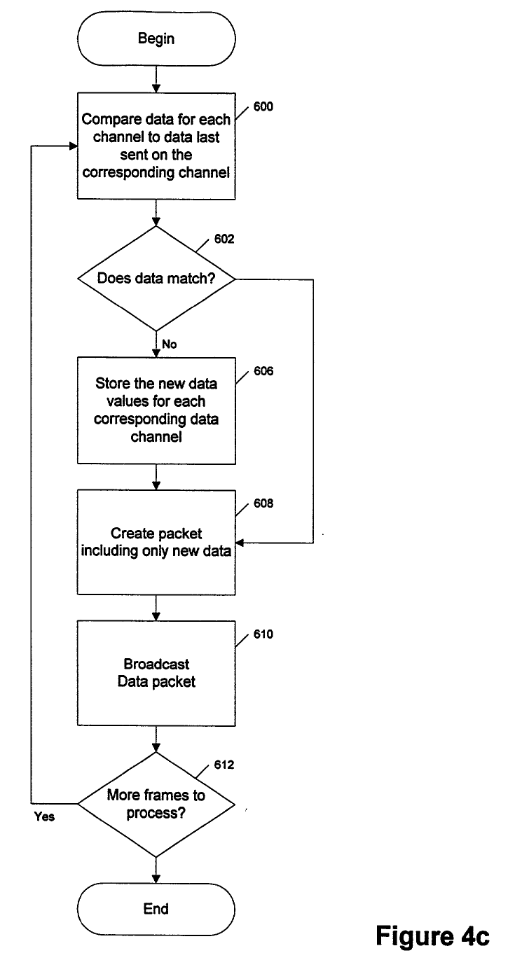

Referring now to FIG. 4, data synchronizer 200 includes circular buffers 400 and 402, a delay element 404, an audio file reader 406, a frame reader 408, double buffers 410 including input and output sections 412 and 414, respectively, delay buffers 416 and controller 418.

Data synchronizer includes a double buffer 410 for each device group (or channel group) coupled to motion data interface 210 (one or more for body suit data, one for keyboard data, etc.) and a circular buffer 402 for each time-based data input stream. The number of delay buffers 416 associated with each device is determined by the delay time for data received from the given device relative to the various delays of other input data received from other devices coupled to data synchronizer 200. The construction and determination of the number of delay buffers for each device is described in greater detail below.

The data received by data synchronizer 200 is one of two different types, motion data and time-based data. Motion data is received as channel inputs from motion data interface 210. Each device connected to motion data interface 210 may include one or more channels of data. The mapping of device inputs to channels provided as input to the data synchronizer is defined by motion data interface mapper 312. User interface 302 allows for the easy manipulation of the mapping function.

Data synchronizer 200 receives as an input from each device a time stamp and data on one or more channels. The motion data sensor connected to bodysuit 116 may include one hundred and forty channels of data and two channels of timing information (time stamp information for synchronizing the data streams).

Referring now to FIGS. 4 and 4a, a state diagram describing the processes executed to provide real time synchronized motion and time-based data to a client from a server as implemented by server 100 includes: an initialization state 450, a measurement state 452 and an execution state 454.

During initialization state 450, motion data interface 210 retrieves one or more motion data streams and assigns data channels to the input streams resulting in an input channel mapping for data in the output motion data stream 314. Time-based data interface 208 retrieves one or more time-based data streams as inputs including voice data from microphone 114 and provides these as input to data synchronizer 200.

Audio file reader 406 may be initialized by controller 418 to retrieve a pre-recorded file of audio data stored on storage device 110. Audio file reader 406 reads the retrieved audio file and provides audio playback during the execution state locally at server 100 through speaker 112. Audio playback data is provided by audio file reader 406 to circular buffer 400. Pointers associated with circular buffer 400 and the delay through delay element 404 are configured during the measurement state to synchronize the playback of audio data and transfer of digital audio data frames to reader 408 as will be described in greater detail below. Circular buffer 400 may be a digital media ring buffer for capturing and storing voice data. Audio file reader 406 provides digital audio data to delay element 404 for coupling with motion and other time-based data input frames. In one embodiment, delay element 404 is also a digital media ring buffer for capturing and storing voice data whose pointers are configured by controller 418 during measurement state 452. After the channelization is complete, the initialization state ends and data transfers may commence in execution state 454.

Execution state 454 includes the real time transfer of data from the various input streams through server 100 to a client 102. A number of serial operations are performed by components of the server during execution state 454 including data read 462, network channelization 464, packetizing 466 and multicasting 468. Each of these process is described in further detail below.

During execution state 454, server 100 invokes a state transition monitor 460 for monitoring triggers which require a transition from execution state 454 to measurement state 452 or to initialization state 450.

Referring now to FIGS. 4, 4a and 4b, state transition monitor 460 executes in the background on server 100 and is responsive to one or more triggers for initiating the transition to measurement state 452. Data synchronizer 200 may provide a trigger upon receipt of a first frame of data from time-based interface 208 or motion data interface 210. Controller 418 may initiate a trigger based in part on changes detected in one or more input streams received at data synchronizer 200 or in response to a user input.

Measurement state 452 includes the execution of measurement routine 470. Measurement routine 470 begins by purging any delay elements (including delay buffer 404, circular buffers 400 and 402, and variable delay buffers 416 480). Sample data is provided from each of the different devices coupled to motion data interface 210 and time-based data interface 208 in order to determine the delay time associated with the data transfer from the various sensors and storage mechanisms to data synchronizer 200 (482). The delay is calculated based on time stamp information provided with the data for each stream (channel group). The time stamp information may be in the form of an absolute time stamp. The delay time measured for each of the devices is used in determining the number of delay buffers established for each device, the starting locations of the pointers associated with circular buffers 400 and 402 and the size of delay buffer 404.

More specifically, controller 418 calculates the amount of time required to receive a frame of data from each stream (channel group) (484). Based on the calculations a slowest stream is determined (486).

If the slowest stream is not a motion data stream or if the more than one motion data stream is present, then a variable number of delay buffers 416 are required to delay the reading of the frames by frame reader 408 for one or more motion data streams. For each stream the delay difference for the stream as compared to the slowest stream is calculated (490). The delay difference determines the number of delay buffers required and is calculated based on the delay time difference for the respective stream and the frame data rate. The frame data rate is the rate at which frames (packets) are sent over the network. For example, if one motion data stream is identified to be the slowest stream (because it takes the most time to receive a single frame of data), then the number of delay buffers for every other motion data stream may be calculated by dividing the delay difference (in seconds) by the frame rate (in frames per second) to determine the number of frames required to be buffered (rounded down to the next whole number). Thereafter, controller 418 configures the proper number of delay buffers 416 and the sequencing of the transfers between delay buffers in order to provide an appropriate delay to synchronize the data frames (492).

Each delay buffer 416 may be sized to store a single frame of data. Alternatively, a single delay buffer (such as a circular buffer) may be realized including read and write pointers. The write pointer may be used to indicate the starting address in the circular buffer for receiving the next frame of data from the appropriate double buffer 410. The read pointer may be used to indicate the starting address in the circular buffer for reading the next frame of data by frame reader 408.

The measurement routine also includes the calculation of the delay associated with the time-based data. If one of the time-based data inputs is the slowest stream, then no delay time is required for that stream. The read and write pointers for the circular buffer associated with the slow stream are set to indicate consecutive frames in the circular buffer 402 respectively. If however, a time-based data stream is not the slowest stream, then the delay time for the “fast” time-based data streams is calculated (494). The delay difference for a given time-based data stream is divided by the frame rate (for the particular time-based input stream) to determine the number of frames required to be stored. Controller 418 configures the pointers associated with the circular buffers according to the calculated delay in step 494 to provide an appropriate delay to synchronize the data frames (496). While having been described in a serial manner, the delay calculations for each stream may be performed in parallel.

Pre-recorded audio background data may be provided by file storage 110. The audio background data may take the form of music or background audio which is to be included and synchronized with the motion data. The audio file includes timing information associated with the particular synchronization of the audio data to the particular motion data desired. As described above, data synchronizer 200 includes a reader 406 for retrieving the audio file from a portion of memory in the server or other memory location. The reader interprets the audio file and provides as an output digital data and analog output data. The analog output data is driven out to speaker 112 which may be used to playback the audio music locally. To assure the synchronization of the motion data with the music provided as part of the audio file, delay elements 400 and 404 are provided. The synchronization of voice data, motion data and audio output requires that the output of the delay element 400 in analog form be in synchronization with the data received at the circular buffer 402 from the voice data device. In this way, the music being played will be in synchronization with the voice data received at the data synchronizer 200.

In addition, the output of the reader 406 (the digital data) must be delayed by a delay element 404 so that the reader receives the appropriate music data in synchronization with the data that is extracted from the circular ring buffer associated with any other time-based data streams (voice data). When the last of the delay buffers are configured, the measurement state terminates and server 100 transitions back to execution state 454.

Data read process 462 operates to extract frames of data from the various delay elements and double buffers. Double buffers 410 provide a portion of memory in data synchronizer 200 for writing full frames of channel data for each device coupled to motion data interface 210. Double buffers 410 may include an input section 412 and an output section 414. The input section 412 is sized to store a single frame of motion data and is made available to receive a next frame of data from motion data interface 210. Output section 414 of double buffers 410 is also sized to store a single frame of motion data. The output section of double buffers 410 may be read by frame reader 408 directly, or may transfer their contents to a sequence of variable delay buffers 416 depending on the delay calculated for the given stream. A double buffering scheme is preferable to allow for the operation of separate threads executing on server 100 for the writing of data to data synchronizer 200 and the reading of synchronized frames by frame reader 408.

When the double buffer receives a frame of data from motion data interface 210, the data is written into the input section of the double buffer. Thereafter the data may be transferred to the output portion of the buffer for transfer to frame reader 408. The input and output sections of the double buffers may be configured to be able to both receive data from the motion data module or write data to the frame reader. In this configuration, the motion data interface may write to whichever section of the double buffer is free.

Reader 408 extracts music data, audio data and other motion sensor data from the various locations within the synchronizer 200. At a designated frame rate, reader 408 reads a frame of data for each stream from the delay buffers 416, double buffers 410, delay buffer 404 and circular buffer 402.

Network channelization process 464 provides a mapping of the input channel data received from motion data interface 210 and time-based data interface 208 to network channels for multicast over network 103 (FIG. 2). Reader 408 includes a channel mapper 409 and a description file 411 for mapping data from each channel in a given frame to create a network channel mapping. Channel mapper 409 may include a table displayed through a graphical user interface to a user. The table may be manipulated by the user to provide a specific grouping of sensor inputs that are to multicast over the network in specified network channels. The grouping is stored in description file 411. Channel mapper 409 uses the grouping information stored in description file 411 to provide one or more serial output streams 413 (one for each network channel) to object list module 201. The grouping information stored in description file 411 defines the specific combinations and ordering of input channel data which is to be used in multicasting the motion and time-based data frames. Each network channel is named and a descriptor for the data contained therein is provided as part of a network descriptor packet which is multicast over the network as will be described in further detail below.

Object list module 201 includes a monitor 441, a channel list 442, a local memory 443 and a descriptor module 444. Channel list 442 is a buffer used to store network channel data steams received from reader 408. Memory 443 is used to store a copy of the last data values transmitted for each network channel. Monitor 441 monitors the data received on each network channel and stores the data in channel list 442. Data values for each channel may be transmitted from the channel list 442 to packetizer 202 and out to the various different client devices. Alternatively, only changed data which reflects changes in the last data values transmitted for a given channel are transmitted. Associated with channel list 442 is a flag for each network channel which may be set by monitor 441 if the data received is different than the last data values transmitted over the network channel. Packetizer 202 reads data from channel list 442 only if the flag for the network channel has been set.

Descriptor module 444 provides descriptor information that may be transmitted over the network interlaced with data packets at user defined intervals. The descriptor information includes channel information associated with all data channels to be included in a network packet. This allows any client to join in real time after a program has begun a multicast. The descriptor packet may be transmitted every five (5) seconds. In order to allow for clients to join programming already in progress, an entire network package is sent immediately after the transmission of a descriptor packet. This may be accomplished by setting all the flags in the channel list irrespective of the data values received for the next network frame.

Packetizing process 466 operates to package the descriptor information derived by the channelization process and the sensor data. Specifically, packetizer 202 converts the data into a network independent format for easy transfer across the network to one or more client devices. The format is UDP for most data transfers. Packetizer 202 includes a packet generator 495.

Packet generator 495 produces network packets including a header and data fields. The header includes protocol and destination information associated with the transmission of the data across network 103. The data field may include descriptor information for identifying the contents of individual network channels and sensor data. Packetizer 202 reads data from channel list 442, formats the data into a network packet and transfers the network packets to multicaster 206. In one embodiment, packetizer 202 includes a packet sequencer 497. In some network environments, packets may be received at a client out of order. A sequence ID for each packet generated and output from multicaster 206 is provided as part of the header field. In this way, packets received by a client may processed in the proper order.

A playback and record module 204 may be included in server 100. Playback and record module 204 allows for the storage of packets in a storage device 300 (e.g., hard disc or other storage device) rather than transfer directly from the multicaster to other clients. At a subsequent point in time, the playback and record module may be used to retrieve the packet information stored in storage device 300 and then output the packets through the multicaster to the various clients across the network.

Multicasting process 468 operates to transfer network packets over network 103 to one or more clients 102. Multicaster 206 includes one or more drivers for transmitting packets according to a standard network protocol from the server to one or more of the client devices.

Referring now to FIG. 4c, a process for transmitting data through a server to minimize the network bandwidth requirements includes comparing data received on each channel of an input stream with the data value last transmitted over the network for this channel (600). If the data value does not match (602), then the new data value is stored in a memory (604). Thereafter, a packet is generated that includes only changed data values (608). The packet is then multicast over the network (610). The process repeats for all received data frames (612). Intermittently descriptor channels may be multicast followed by full data frames to allow for remote clients to join a transmission in progress.

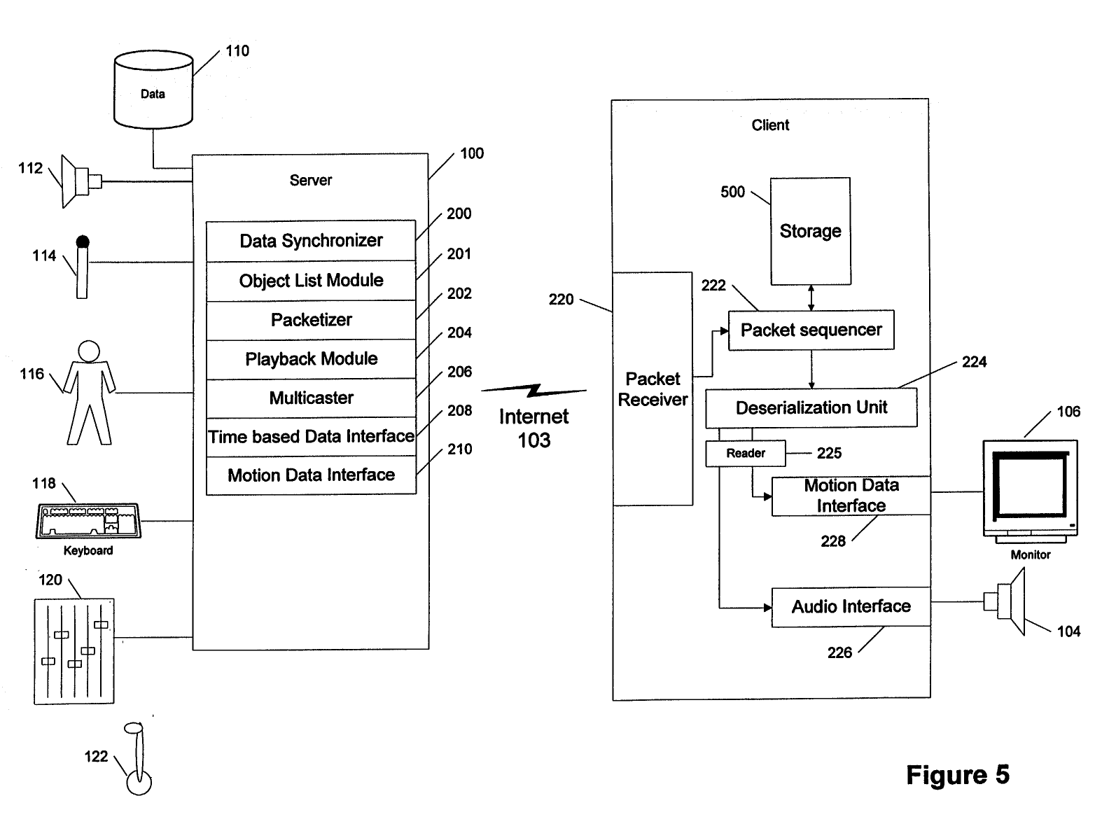

Referring now to FIG. 5, client 102 includes a packet receiver 220, a packet sequencer 222, storage 500, a deserialization unit 224, a reader 225 and audio 226 and motion data interfaces 228. Packets are received by packet sequencer 222 and either stored in storage 500 or provided to deserialization unit 224. Packets are transferred in sequence order to deserialization unit 224 for extracting the channel data from a given packet.

Deserialization unit 224 extracts data for each channel from each packet and provides the data to reader 225. Client 102 may process data packets slower than they are delivered from a server. Each network frame received is read and the respective audio and motion data are separated. The motion data is provided to motion data interface 228 for transfer and display on monitor 106. Audio data is transferred to audio interface 226 for transfer and playback on audio speaker 104. Reader 225 may be a browser application executing on client 102. Reader 225 includes a mapper (not shown) for mapping the network descriptor channel information to VRML events. Data from the network channels is mapped to VRML events which may be used to control the motion of objects in a 3D scene displayed on monitor 106. The browser may be a Universal Cosmo Player (VRML browser) produced by Silicon Graphics, Inc, of Mountain View, California. The VRML browser may be used to process the VRML events. The VRML browser reads avatar data in the form of VRML files and displays an avatar on monitor 106. VRML browser receives and routes VRML events to the appropriate parts of the avatar to control its motion.

Reader 225 may perform audio and motion data mixing as required. Alternatively, mixing may occur in the audio or motion data interface.

Data processing at the client may be slower than the rate at which frames are received at the packet receiver. The desrialization process may be too slow, or alternatively, the read process performed by the VRML browser may be too slow. Accordingly, packet receiver 220 may include one or more buffers sized to hold a predefined number of data packets. Old motion data that has not been extracted from the buffer may be discarded as new motion data is received. Audio data may not be discarded so as to avoid holes or breaks in the audio playback. The buffers may be located at the packet receiver or other location in the client as required.

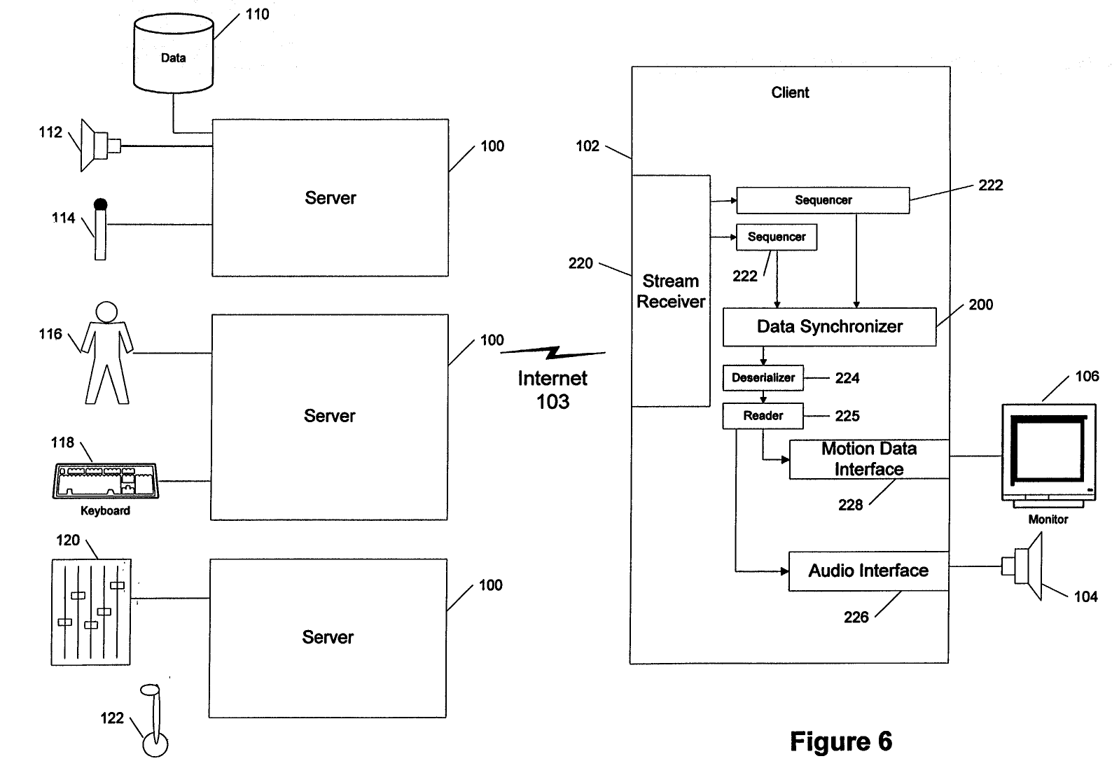

Referring now to FIG. 6, in other embodiments, client 102 may include a data synchronizer 200. Client 102 may receive as inputs two or more motion and time-based data streams over network 103. The inputs may be provided from one or more servers. Each stream received is processed by a sequencer 222 and provided to the data synchronizer 200. In order to synchronize the various data streams, each motion stream includes a timing stamp. The time stamp is synchronized with the time-based data to yield synchronized frames for output to deserializer 224. No packetizer is required for local playback. The motion and time-based data may then be transferred to the reader 225 for processing as described previously.

The present invention has been described in terms of specific embodiments, which are illustrative of the invention and are not to be construed as limiting. The invention may be implemented in hardware, firmware or software, or in a combination of them. Other embodiments are within in the scope of the following claims.

What is claimed is:

1. A method of synchronizing asynchronous time-based and motion data in a system in which the time-based data and motion data are transmitted by a server over a network to a client, the method comprising:
retrieving a time-based data stream and a motion data stream at the server, each stream comprising frames of data;
variably buffering one of the time-based data stream and the motion stream to produce two streams having synchronized frames; and
using the synchronized frames at the client for playback of synchronized motion and time-based data to a user.

2. The method of claim 1 wherein the variably buffering occurs at the server.

3. The method of claim 1 further including calculating a difference between delays for the motion stream and the time-based data stream through the server to determine an amount of variable buffering for a faster of the two streams.

4. The method of claim 1 further including transferring only those data values for a frame that have changed since a last frame was transmitted.

5. The method of claim 1 wherein the network is the Internet.

6. The method of claim 1 wherein the motion data is mapped to control the movement of a virtual figure displayed in a scene at the client.

7. The method of claim 1 wherein the motion data is generated by a body suit.

8. The method of claim 1 wherein the motion data includes background data for use in producing a scene at the server.

9. The method of claim 1 wherein data transfer from the server to the client is concurrent with the receipt of the time-based data stream and motion data stream at the server.

10. The method of claim 1 wherein the time-based data is voice data.

11. The method of claim 1 wherein the synchronized data frames include one or more data channels, the server transmitting on the network at a predetermined interval between synchronized data frames a descriptor packet which describes each channel contained in the synchronized data frames such that a client may join in progress a multicast of synchronized data frames.

12. The method of claim 1 wherein the time-based data is a pre-recorded audio track and the method further includes synchronizing playback of the pre-recorded audio track at the server and buffering of the pre-recorded audio track to allow for coupling with motion data generated in time with the playback of the pre-recorded audio track.

13. The method of claim 1 further including sequencing synchronized frames output from the server to the client to provide for ordered playback of the synchronized frames to a user at the client.

14. A method of packaging synchronized frames of data where each frame includes one or more channels of data in a system in which synchronized frames are transmitted by a server over a network to a client, the method comprising:
storing a last data value for each channel in each frame transmitted over the network;
retrieving new synchronized frames for transmission over the network; and
packaging and transmitting over the network only data for channels having changed data values.

15. The method of claim 14 further including transmitting a descriptor packet at a predetermined interval over the network, the descriptor packet including channel descriptors for each channel in the synchronized frames.

16. An apparatus for synchronizing asynchronous time-based and motion data in a system in which the time-based data and motion data are transmitted by a server over a network to a client, the apparatus comprising:
a data retriever for retrieving a time-based data stream and a motion data stream at the server, each of the streams comprising frames of data;
a data stream synchronizer for buffering one of the time-based data stream and the motion stream to produce two streams having synchronized frames; and
a packetizer for packaging synchronized frames of motion data and time-based data for use at the client for playback of synchronized motion and time-based data to a user.

17. The apparatus of claim 16 further including a multicaster for multicasting the synchronized motion and time-based data to clients coupled to the network.

18. The apparatus of claim 16 wherein the packetizer includes a storage device and a comparator, the storage device for storing data values last transmitted over the network for each channel in each of the synchronized frames, the comparator for comparing data values for new frames with the data values stored in the storage device, the packetizer only packaging for transmission to the client channel data for channels having changed data values as determined by the comparator.

19. A method for playing back time-based and motion based data that has been synchronized comprising:
mapping the motion based data to control the movement of a virtual figure in a scene displayed at a client; and
playing back in synchronization with movement of the virtual figure the time-based data.

20. A method of synchronizing asynchronous motion and audio data in a system in which the motion and the audio data are transmitted by a server computer to one or more clients, the clients providing a real time output of synchronized motion and audio data, the method comprising:
retrieving an audio stream including voice data and a motion data stream including one or more motion data channels at the server, each streams including frames of data;
calculating a delay through the server for a frame of data on each of the streams;
calculating a difference between the delay for the audio stream and the motion data stream to determine which of the two streams is faster;
variably buffering a faster of the streams to synchronize the audio stream and the motion data stream resulting in two output streams having synchronized data frames;
packaging the synchronized data frames;
multicasting the synchronized data frames to one or more clients over a network;
at each client computer, using the synchronized data frames for synchronous playback of the audio and motion data for display to a user.
